(19) United States
(12) Patent Application Publication
(10) Pub. No.: US 2015/0201091 A1
(43) Pub. Date: Jul. 16, 2015

(54) INFORMATION PROCESSING SYSTEM THAT USES SHORT-RANGE WIRELESS COMMUNICATION AND METHOD OF CONTROLLING THE SAME, MOBILE INFORMATION TERMINAL, AND STORAGE MEDIUM

(71) Applicant: CANON KABUSHIKI KAISHA, Tokyo (JP)

(72) Inventor: Hidehiko Yokoyama, Machida-shi (JP)

(21) Appl. No.: 14/588,681

(22) Filed: Jan. 2, 2015

(30) Foreign Application Priority Data
Jan. 10, 2014 (JP) 2014-003231

(51) Int. Cl. H04N 1/00; H04B 5/00

(52) U.S. Cl. CPC H04N 1/00106; H04N 1/00214; H04N 1/00307; H04B 5/0031; H04N 2201/0094

(57) ABSTRACT

A control technique that enables a mobile information terminal to easily acquire image data obtained by scanning an original from an image forming apparatus using short-range wireless communication. According to detection of proximity of a mobile terminal, short-range wireless communication is established between the mobile terminal and an image forming apparatus, and the image forming apparatus reads an original to generate image data, and transmits the generated image data to the mobile terminal by using wireless communication. The mobile terminal receives the image data from the image forming apparatus by using the wireless communication, and determines whether or not an application associated with the image data is active. If the application associated with the image data is not active, the mobile terminal starts the application.

### BACKGROUND OF THE INVENTION

1. Field of the Invention

The present invention relates to an information processing system and a method of controlling the same, a mobile information terminal, and a storage medium, and more particularly to a control technique for easily taking in image data read by an image forming apparatus into a mobile information terminal by using short-range wireless communication.

2. Description of the Related Art

In recent years, there have been increasingly used mobile information terminals, such as a smartphone and a tablet terminal, equipped with a short-range wireless communication technique, such as NFC, FeliCa (trademark), MIFARE (trademark), and Bluetooth (registered trademark). Accordingly, image forming apparatuses, such as a multifunction peripheral, are also equipped with the short-range wireless communication technique, whereby various cooperative operations are performed between a mobile information terminal and an image forming apparatus. For example, there has been disclosed a technique for transmitting a scan instruction and a file name from a mobile information terminal to an image forming apparatus using short-range wireless communication, and storing data obtained by scanning an original using the image forming apparatus, with the file name designated from the mobile information terminal (see Japanese Patent Laid-Open Publication No. 2010-130656).

When a mobile information terminal acquires image data obtained by scanning an original using the image forming apparatus, a method is used in which a scan application is started on the mobile information terminal, and remote scan is performed through a user's operation on the scan application to acquire the image data.

Further, a method is also used in which an E-mail with image data obtained by scanning attached thereto is transmitted from the image forming apparatus to the mobile information terminal, and the image data is obtained by starting an E-mail application on the mobile information terminal and storing the image data attached to the E-mail.

However, when using the method of starting the scan application on the mobile information terminal to obtain image data, a user is required to make various settings concerning the identification of the image forming apparatus and the scan function, which is not easy for the user.

Further, when using the method of transmitting an E-mail by attaching image data thereto, the image data attached to the E-mail and the scan application cannot be associated with each other, and hence it is not easy to use the image data.

### SUMMARY OF THE INVENTION

The present invention provides a control technique for enabling a mobile information terminal to easily acquire image data obtained by scanning an original from an image forming apparatus by using short-range wireless communication.

In a first aspect of the present invention, there is provided an information processing system including a mobile terminal and an information processing apparatus, that is capable of performing wireless communication between the mobile terminal and the information processing apparatus by using short-range wireless communication and wireless communication which is different from the short-range wireless communication, wherein the information processing apparatus comprises a processing unit configured to perform predetermined processing when the short-range wireless communication is established between the information processing apparatus and the mobile terminal, and a transmission unit configured to transmit a processing result of the predetermined processing to the mobile terminal by using the wireless communication, wherein the mobile terminal comprises a reception unit configured to receive the processing result from the information processing apparatus by using the wireless communication, and a starting unit configured to start, when the reception unit has received the processing result, an application associated with the processing result.

In a second aspect of the present invention, there is provided a mobile terminal that is capable of performing short-range wireless communication and wireless communication which is different from the short-range wireless communication, comprising a first acquisition unit configured to acquire predetermined information from an information processing apparatus by using the short-range wireless communication, a second acquisition unit configured to connect to the information processing apparatus by using the wireless communication based on the predetermined information to thereby acquire a processing result of predetermined processing performed by the information processing apparatus from the information processing apparatus, and a starting unit configured to start, when the second acquisition unit has acquired the processing result, an application associated with the processing result.

In a third aspect of the present invention, there is provided a method of controlling a mobile terminal that is capable of performing short-range wireless communication and wireless communication which is different from the short-range wireless communication, comprising acquiring predetermined information from an information processing apparatus by using the short-range wireless communication, accessing the information processing apparatus by using the wireless communication based on the predetermined information to thereby acquire a processing result of predetermined processing performed by the information processing apparatus from the information processing apparatus, and starting, when the processing result has been acquired, an application associated with the processing result.

In a fourth aspect of the present invention, there is provided a non-transitory computer-readable storage medium storing a computer-executable program for performing a method of controlling a mobile terminal that is capable of performing short-range wireless communication and wireless communication which is different from the short-range wireless communication, wherein the method comprises acquiring predetermined information from an information processing apparatus by using the short-range wireless communication, accessing the information processing apparatus by using the wireless communication based on the predetermined information to thereby acquire a processing result of predetermined processing performed by the information processing apparatus from the information processing apparatus, and starting, when the processing result has been acquired, an application associated with the processing result.

According to the present invention, the mobile information terminal equipped with the short-range wireless communication technique is moved close to the image forming apparatus to thereby make it possible to scan an original to generate electronic data in the image forming apparatus, and take in the electronic data into the mobile information terminal so as to process the electronic data in cooperation with the scan application or the like.

Further features of the present invention will become apparent from the following description of exemplary embodiments (with reference to the attached drawings).

### BRIEF DESCRIPTION OF THE DRAWINGS

FIG. 1 is a block diagram of the internal configuration of a mobile information terminal according to a first embodiment of the present invention.

FIG. 2 is a block diagram of the internal configuration of an image forming apparatus equipped with a short-range wireless communication function.

FIG. 3 is a flowchart of a scanning process using short-range wireless communication, which is performed by the image forming apparatus when the mobile information terminal shown in FIG. 1 is moved close to the image forming apparatus shown in FIG. 2.

FIG. 4 is a flowchart of a scanned image transmission process performed by the image forming apparatus.

FIG. 5 is a diagram showing an example of a table that associates a token, a notification ID, and scanned data, which are managed by the mobile information terminal shown in FIG. 1.

FIG. 6 is a flowchart of a scan monitoring process performed by the mobile information terminal.

FIG. 7 is a flowchart of a scanned image acquisition process performed in a step in FIG. 6.

FIG. 8 is a flowchart of a notification process performed in a step in FIG. 6.

FIG. 9 is a diagram showing an example of a token which is sent and received between the image forming apparatus and the mobile information terminal, for uniquely identifying the scanning process.

FIG. 10 is a diagram showing an example of a scanned image data table for managing a token, a state of the scanning process, and scanned image data, by the image forming apparatus.

FIG. 11 is a flowchart of a scanned image acquisition process performed by a mobile information terminal according to a third embodiment.

FIG. 12A is a diagram showing an example of an initial screen displayed on the mobile information terminal.

FIG. 12B is a diagram showing an example of the initial screen displaying a notification of completion of the scanning process.

FIG. 13A is a diagram showing an example of the initial screen of the mobile information terminal, which displays a plurality of notifications of completion of the scanning process.

FIG. 13B is a diagram showing an example of a scan setting screen displayed on the mobile information terminal.

FIG. 14A is a diagram showing an example of a resolution setting screen displayed when making scan settings on the mobile information terminal.

FIG. 14B is a diagram showing a scanned image display screen displayed on the mobile information terminal.

FIG. 14C is a diagram showing a scan-in-progress screen displayed on the mobile information terminal.

### DESCRIPTION OF THE EMBODIMENTS

The present invention will now be described in detail below with reference to the accompanying drawings showing embodiments thereof.

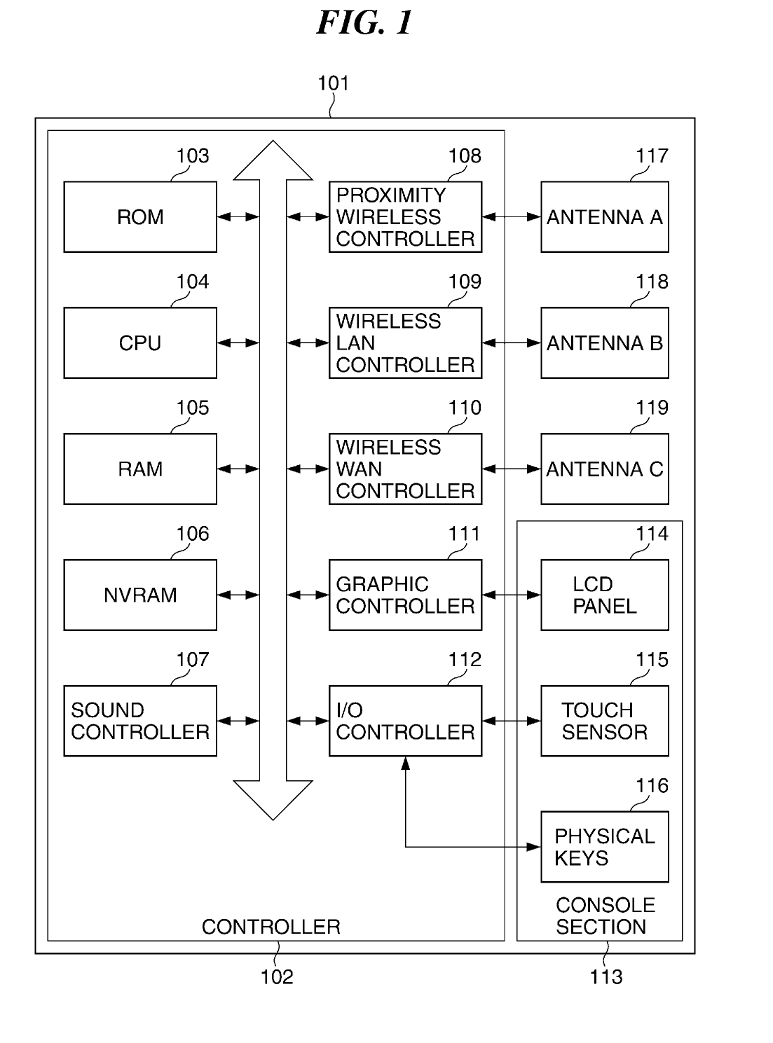

FIG. 1 is a block diagram of the internal configuration of a mobile information terminal according to a first embodiment of the present invention.

Referring to FIG. 1, the mobile information terminal, denoted by reference numeral 101, is formed e.g. by a smartphone or a tablet terminal equipped with a short-range wireless communication function, and is comprised of a controller 102, a console section 113, an antenna A 117, an antenna B 118, and an antenna C 119.

The controller 102 includes a ROM 103 which is a nonvolatile memory storing a system boot program and an operating system (OS), and a RAM 105 which is a volatile memory for temporarily storing programs and data. Further, the controller 102 includes an NVRAM 106 which is a nonvolatile memory for storing application programs (hereinafter simply referred to as the “applications”) and data associated with the applications. The programs stored in the ROM 103, the RAM 105, and the NVRAM 106 are executed by a CPU 104.

Further, the controller 102 includes a sound controller 107 that is connected to a speaker (not shown) and a microphone (not shown) to input and output sound.

The controller 102 includes a proximity wireless controller 108 that controls short-range wireless communication, such as NFC (Near-Field Communication), FeliCa (trademark), and MIFARE (trademark), with other devices via the antenna A 117. The proximity wireless controller 108 is an example of a first communication unit.

The controller 102 includes a wireless LAN controller 109 that controls short-range wireless communication including wireless LAN, such as IEEE 802.11n, and Bluetooth (registered trademark), with other devices via the antenna B 118. The wireless LAN controller 109 is an example of a second communication unit.

The controller 102 includes a wireless WAN controller 110 that controls a wireless WAN, such as mobile phone network communication including LTE (Long Term Evolution), with other devices via the antenna C 119.

The controller 102 further includes a graphic controller 111 that performs display on an LCD panel 114 (display device), and an I/O controller 112 that controls input/output of data between the controller 101 and other devices and elements.

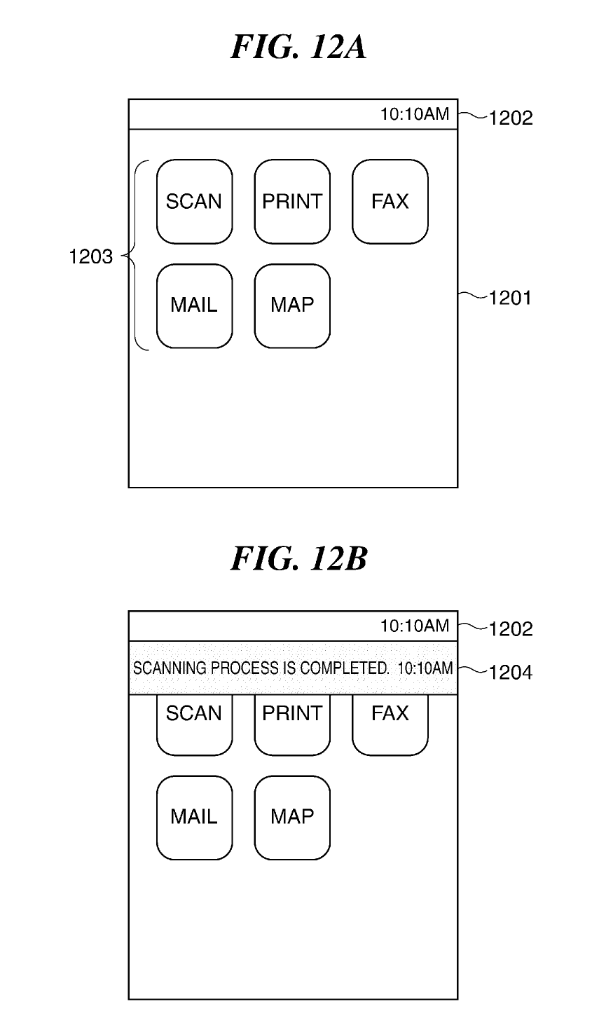

The console section 113 includes the LCD panel 114 that is connected to the graphic controller 111 to display images and information, a touch sensor 115 that detects a position where a user touches with his/her finger or a touch pen, and physical keys 116, such as a confirmation button. FIG. 12A shows an example of a screen displayed on the LCD panel 114. The other devices and elements mentioned above include the touch sensor 115 and the physical keys 116.

Referring to FIG. 12A, the display screen of the mobile information terminal 101 displays a desk top area 1201 and a status line 1202.

The status line 1202 displays the current time, network connection information, and so forth.

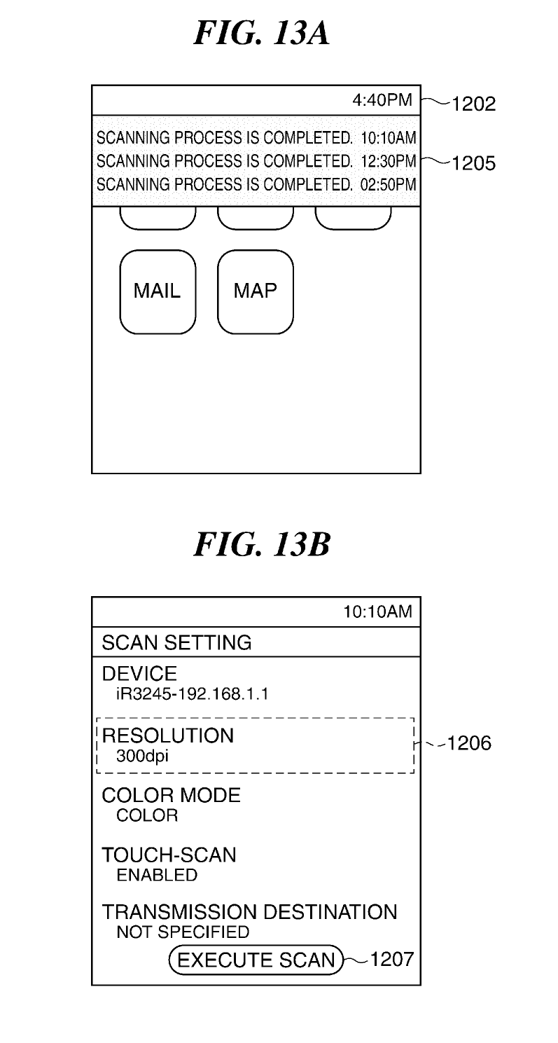

The desk top area 1201 displays a plurality of icons 1203. When a user touches a desired icon, an application associated with the touched icon is started, and the display is changed to an operation/setting screen for the application. For example, when a SCAN icon associated with a scan application is touched, the scan application is started, and the display is changed to a scan setting screen shown in FIG. 13B.

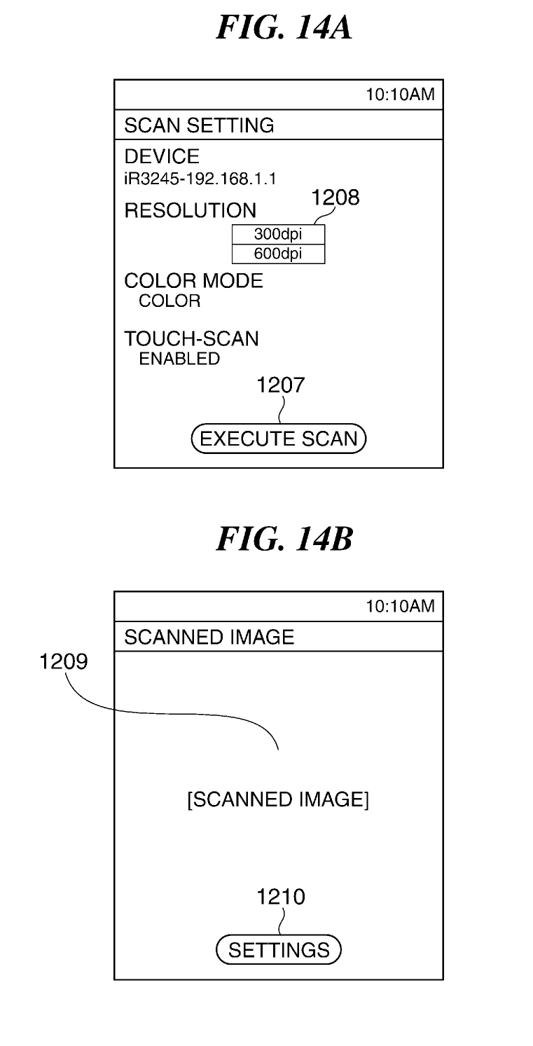

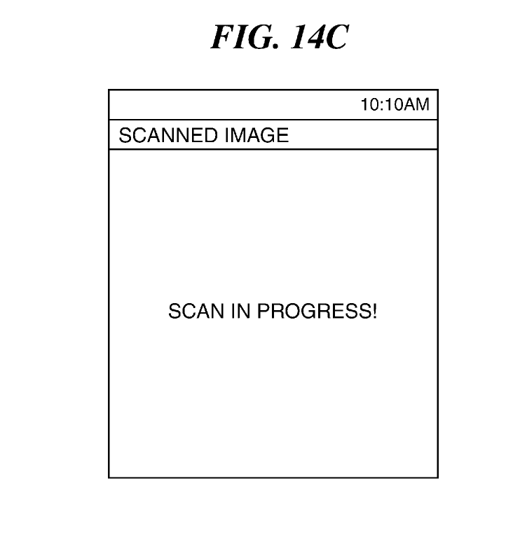

If the user touches a resolution area 1206 displayed on the scan setting screen shown in FIG. 13B, selection items 1208 appearing in FIG. 14A are displayed. The user can set the resolution by touching one of 300 dpi and 600 dpi as the selection items 1208 appearing in FIG. 14A.

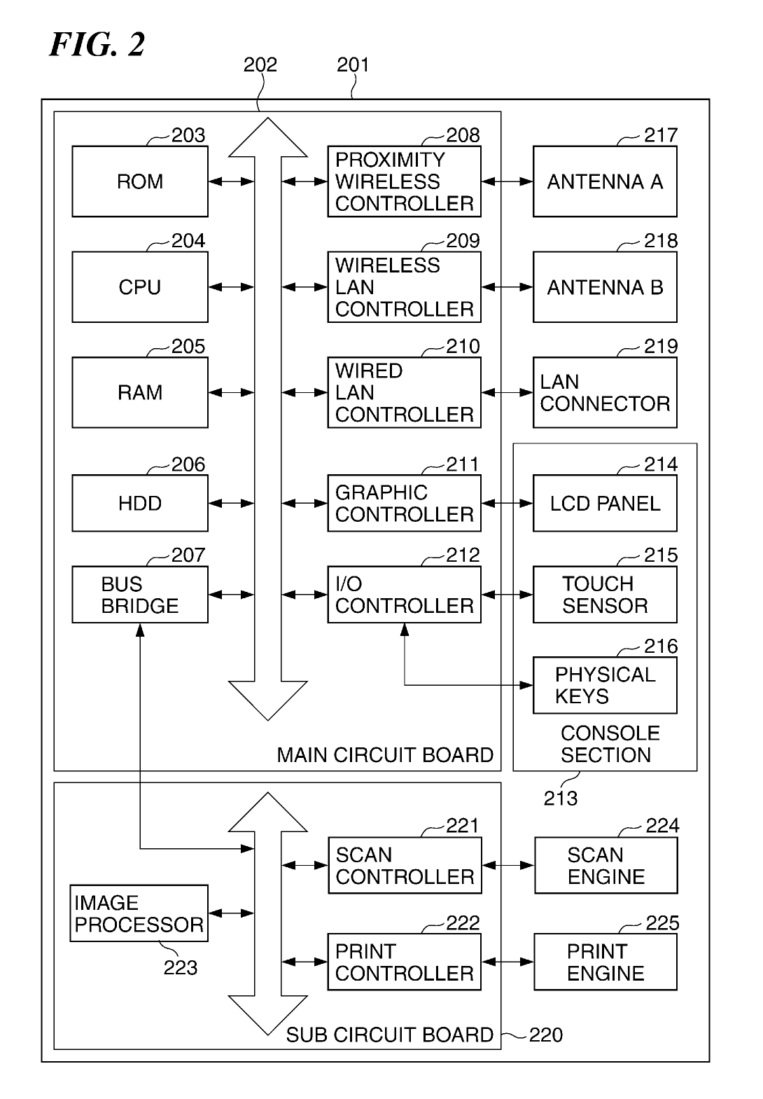

FIG. 2 is a block diagram of the internal configuration of an image forming apparatus equipped with the short-range wireless communication function.

Referring to FIG. 2, the image forming apparatus, denoted by reference numeral 201 includes a main circuit board 202, a sub circuit board 220, a scan engine 224, a print engine 225, an antenna A 217, an antenna B 218, a LAN connector 219, and a console section 213, which are mounted in a casing, not shown.

The main circuit board 202 includes a ROM 203 which is a nonvolatile memory storing a system boot program and an operating system (OS), and a RAM 205 which is a volatile memory for temporarily storing applications and data. Further, the main circuit board 202 has a hard disk drive (HDD) 206 mounted thereon, which is a nonvolatile memory for storing the applications and data associated with the applications. The programs stored in the ROM 203, the RAM 205, and the HDD 206 are executed by a CPU 204.

The main circuit board 202 includes a proximity wireless controller 208 that controls short-range wireless communication, such as NFC (Near Field Communication), with other devices via the antenna A 217.

The main circuit board 202 also includes a wireless LAN controller 209 that controls short-range wireless communication, such as IEEE 802.11n and Bluetooth (registered trademark), with other devices via the antenna B 218, and a wired LAN controller 210 that sends and receives data to and from other devices connected to a LAN via the LAN connector 219. Further, the main circuit board 202 includes a graphic controller 211 that performs display on an LCD panel 214 (display device), and an I/O controller 212 that controls input/output of data between the main circuit board 202 and other devices and elements.

The console section 213 includes the LCD panel 214 that is connected to the graphic controller 211 to display image information, a touch sensor 215 that detects a position where a user touches with his/her finger or a touch pen, and physical keys 216, such as an execution button and numeric keys. The other devices and elements mentioned above include the touch sensor 215 and the physical keys 216.

The main circuit board 202 includes a bus bridge 207 that exchanges data with a bus of the sub circuit board 220.

The sub circuit board 220 includes a scan controller 221 that controls the scan engine 224, and a print controller 222 that controls the print engine 225. Further, the sub circuit board 220 includes an image processor 223 that processes scanned image data obtained by the scan engine 224, and image data to be output by the print engine 225.

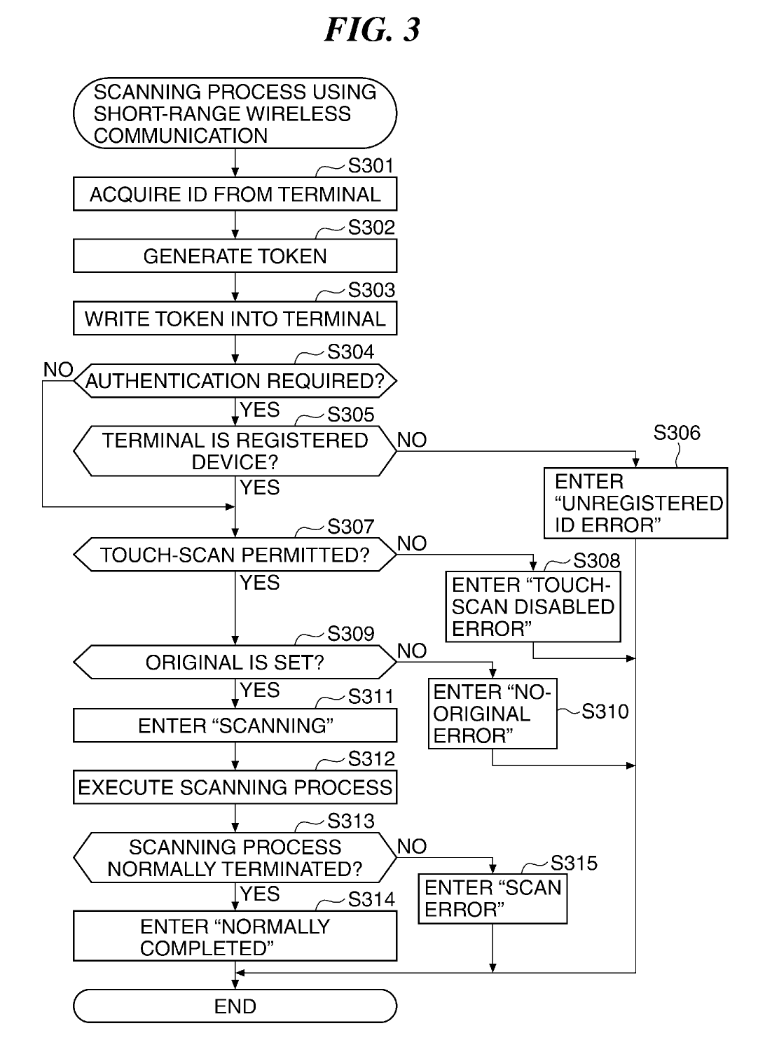

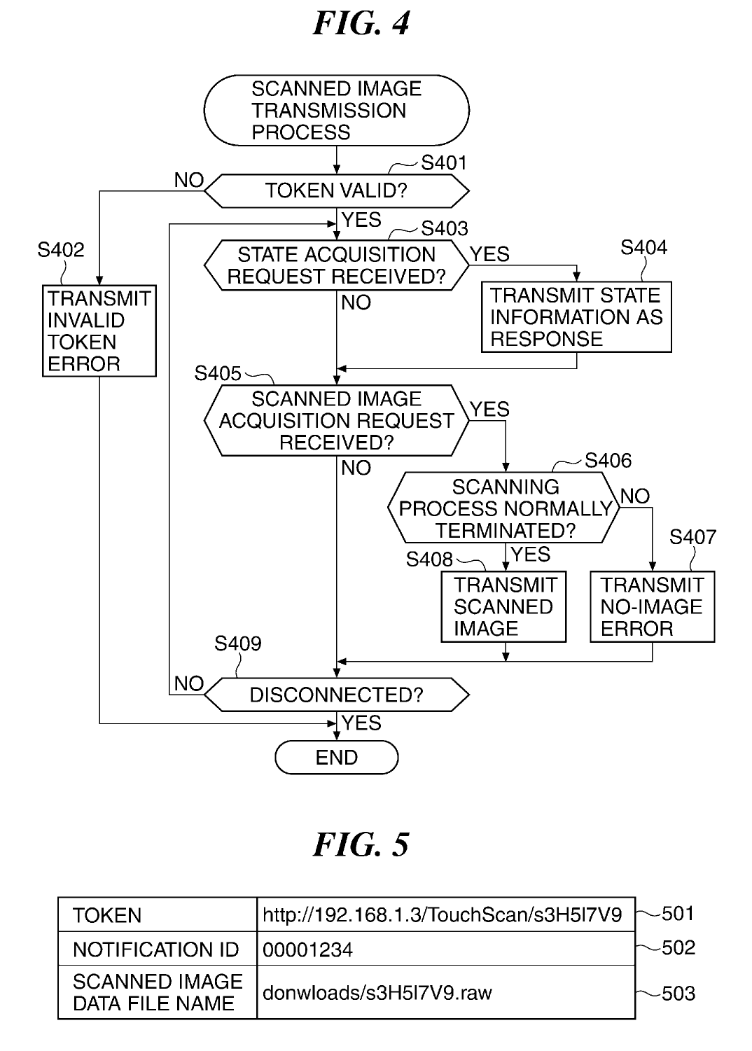

Next, with reference to FIGS. 3 and 4, a description will be given of a scanning process using short-range wireless communication, which is performed in an information processing system comprised of the mobile information terminal 101 shown in FIG. 1 and the image forming apparatus 201 shown in FIG. 2, by the image forming apparatus 201 when the mobile information terminal 101 is moved close to the image forming apparatus 201.

FIG. 3 is a flowchart of the scanning process using short-range wireless communication, which is performed by the image forming apparatus 201 when the mobile information terminal 101 is moved close to the image forming apparatus 201. The present process is realized by the CPU 204 executing a device control program stored in the HDD 206.

Referring to FIG. 3, in the image forming apparatus 201, when the proximity wireless controller 208 detects proximity of the mobile information terminal 101 by short-range wireless communication with the proximity wireless controller 108 of the mobile information terminal 101, the proximity wireless controller 208 sends a notification of the detection to the CPU 204. Then, the CPU 204 acquires a unique ID for uniquely identifying the mobile information terminal 101 from the proximity wireless controller 108 of the mobile information terminal 101 by short-range wireless communication (step S301).

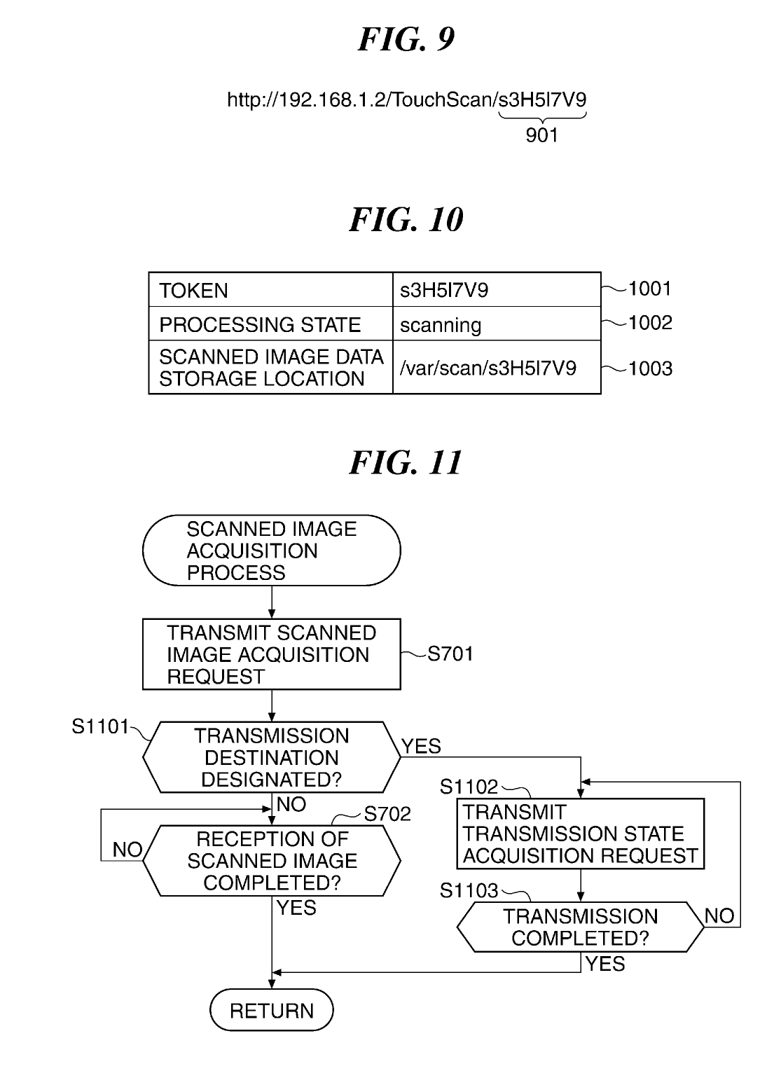

Next, in a step S302, the CPU 204 generates data called a token (identification information) for uniquely identifying the scanning process performed in accordance with the start of short-range wireless communication. The token is a URL (Unified Resource Locator), an example of which is shown in FIG. 9, including a network address and a connection port number of the image forming apparatus 201, which can be accessed e.g. via a wireless LAN. A different token is generated whenever new short-range wireless communication is started, by causing the token to include character strings formed by alphanumeric characters which are generated as required and indicated by reference numeral 901 in FIG. 9 by way of example.

In a step S303, the CPU 204 causes the proximity wireless controller 208 to transmit the token generated in the step S302 to the mobile information terminal 101 (identification information transmission). Upon receipt of the token from the image forming apparatus 201, the proximity wireless controller 108 of the mobile information terminal 101 writes the received token in a nonvolatile memory (not shown).

In a step S304, the CPU 204 refers to device setting information (not shown) of the image forming apparatus 201, stored in the HDD 206, and determines whether or not authentication is required in order to use the image forming apparatus 201. If the requirement of authentication is not set in the device setting information checked by the CPU 204, the process proceeds to a step S307, whereas if the requirement of authentication is set, the process proceeds to a step S305.

In the step S305, the CPU 204 determines whether or not the ID of the mobile information terminal 101, acquired in the step S301, has been registered in a registered device list stored in the HDD 206. The registered device list stores IDs for uniquely identifying devices, respectively. If it is determined that the ID of the mobile information terminal 101 is stored in the registered device list, the process proceeds to the step S307. On the other hand, if it is determined that the ID of the mobile information terminal 101 is not stored in the registered device list, the CPU 204 enters “unregistered ID error” as a processing state in a scanned image data table shown in FIG. 10 (step S306), followed by terminating the present process.

Referring to FIG. 10, the scanned image data table is composed of the token, denoted by reference numeral 1001, generated in the step S302, the processing state associated with the received token, denoted by reference numeral 1002, and a scanned image data storage location 1003 where scanned image data obtained by the scanning process, described hereinafter, is stored. This scanned image data table is stored in the HDD 206.

In the step S307 in FIG. 3, the CPU 204 refers to the above-mentioned device setting information stored in the HDD 206, and determines whether or not execution of a touch-scanning process for starting the scanning process in accordance with connection of short-range wireless communication is permitted (step S307). If it is determined that execution of the touch-scanning process is not permitted, the process proceeds to a step S308, whereas if execution of the touch-scanning process is permitted, the process proceeds to a step S309.

In the step S308, the CPU 204 enters “scan-disable error” as the processing state 1002 in the scanned image data table shown in FIG. 10, followed by terminating the present process.

In the step S309, the CPU 204 determines whether or not an original is set on an original platen glass (not shown) of the scan engine 224 through the control of the scan controller 221. If it is determined that an original is not set, the CPU 204 enters “no-original error” as the processing state 1002 in the scanned image data table shown in FIG. 10 (step S310), followed by terminating the present process.

On the other hand, if it is determined in the step S309 that an original is set, the CPU 204 enters “scanning” as the processing state 1002 in the scanned image data table shown in FIG. 10 (step S311), and performs the scanning process (step S312). This scanning process is performed using the default scan settings of the image forming apparatus 201. The image data obtained by scanning the original is stored in a predetermined area of the HDD 206, indicated by the storage location 1003 of the scanned image data table. The storage location 1003 of the scanned image data table is formed to uniquely indicate the scanned image data storage location which is different on a scanning process operation-by-scanning process operation basis.

When the scanning process in the step S312 is terminated, the CPU 204 determines whether or not the scanning process is normally terminated (step S313), if the scanning process is not normally terminated, the process proceeds to a step S315. On the other hand, if the scanning process is normally terminated, the process proceeds to a step S314.

In the step S315, the CPU 204 enters “scan error” in the processing state 1002 of the scanned image data table shown in FIG. 10, followed by terminating the present process.

In the step S314, the CPU 204 enters “normally terminated” as the processing state 1002 in the scanned image data table shown in FIG. 10, followed by terminating the present process.

Next, with reference to FIG. 4, a description will be given of a scanned image transmission process which is performed by the image forming apparatus 201 when the mobile information terminal 101 accesses the image forming apparatus 201 by using the token generated in the step S303 in FIG. 3.

FIG. 4 is a flowchart of the scanned image transmission process performed by the image forming apparatus 201.

As mentioned hereinabove, the token is formed by a URL including the network address and the connection port number of the image forming apparatus 201. Therefore, if the image forming apparatus 201 is accessed from the mobile information terminal 101 by using the token, the CPU 204 of the image forming apparatus 201 determines whether or not the received token is valid (step S401). As mentioned hereinabove, the token includes a character string (corresponding to part indicated by the reference numeral 901 in FIG. 9) uniquely indicating the scanning process, which is generated at the start of short-range wireless communication. If the character string (or information associated with the character string) is not found in the item of the token of the scanned image data table shown in FIG. 10, it is determined that the received token is invalid, and the CPU 204 transmits an invalid token error as a response to this access request (step S402), followed by terminating the present process.

On the other hand, if it is determined in the step S401 that the received token is valid, the process proceeds to a step S403, wherein the CPU 204 determines whether or not a state acquisition request has been received from the mobile information terminal 101. If it is determined that a state acquisition request has been received, the CPU 204 refers to the scanned image data table shown in FIG. 10, and transmits information of the processing state 1002 associated with the received token to the mobile information terminal 101 (step S404), and the process proceeds to a step S405. Note that the information of the processing state 1002 to be transmitted is the information written in the scanned image data table stored in the HDD 206 in association with the token in the step S306, S308, S310, S311, S314, or S315.

On the other hand, if it is determined in the step S403 that a state acquisition request has not been received, the CPU 204 determines whether or not a scanned image acquisition request has been received from the mobile information terminal 101 (step S405). If it is determined that a scanned image acquisition request has not been received, the process proceeds to a step S409.

On the other hand, if it is determined in the step S405 that a scanned image acquisition request has been received, the CPU 204 refers to the scanned image data table shown in FIG. 10, and determines whether or not information of the processing state 1002 associated with the received token is “normally terminated” (step S406). If the information is other than “normally terminated”, it means that normal image data has not been generated, so that the CPU 204 transmits a no-image error (step S407), and the process proceeds to the step S409.

On the other hand, if it is determined in the step S406 that information of the processing state 1002 of the scanned image data table is “normally terminated”, the process proceeds to a step S408.

In the step S408, the CPU 204 acquires scanned image data associated with the received token from the scanned image data storage location 1003 written in the scanned image data table, and transmits the acquired scanned image data. Note that scanned data is deleted, for example, when a predetermined time period elapses, when a free space in the specified area of the HDD 206 is less than a specified value, or when deletion of the image data is explicitly instructed from the mobile information terminal 101 after acquisition of the scanned image data.

In the step S409, the CPU 204 determines whether or not the mobile information terminal 101 has been disconnected from the image forming apparatus 201, and if the mobile information terminal 101 has been disconnected, the CPU 204 terminates the present process, whereas if the mobile information terminal 101 is still connected to the image forming apparatus 201, the process returns to the step S403.

Next, a description will be given of a scan monitoring process performed by the mobile information terminal 101 when the mobile information terminal 101 is moved close to the image forming apparatus 201, with reference to FIGS. 5, 6, 7, and 8.

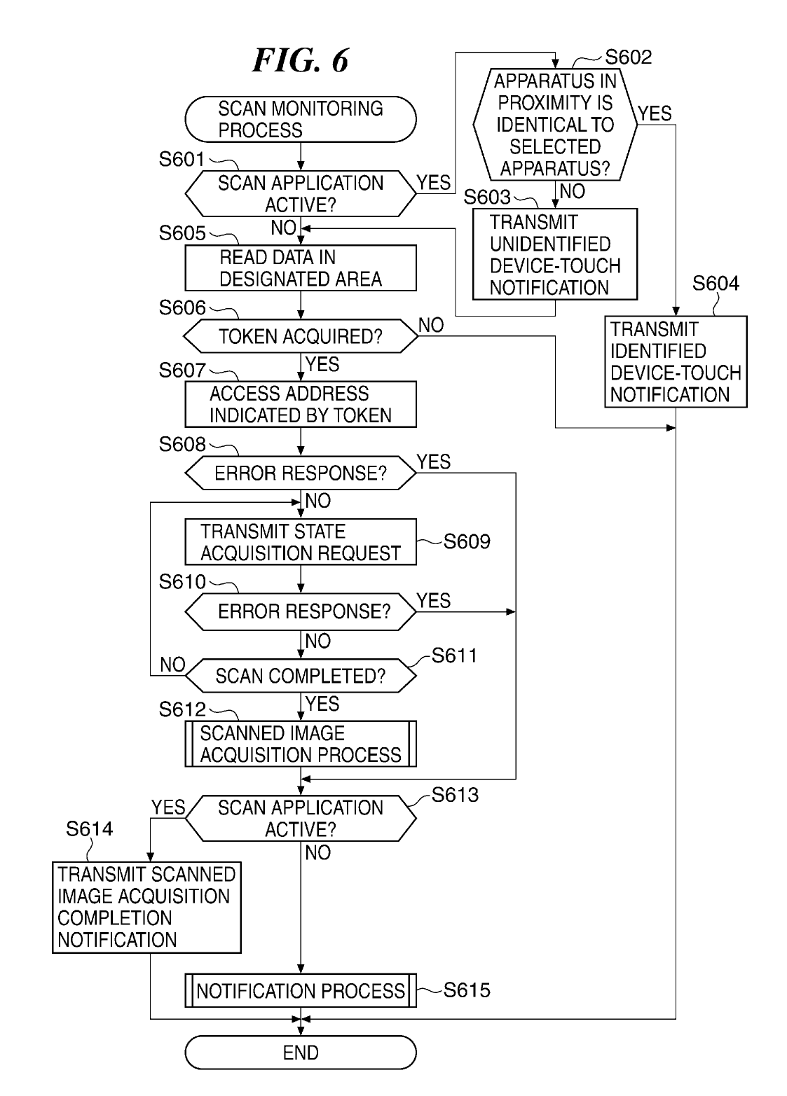

FIG. 6 is a flowchart of the scan monitoring process performed by the mobile information terminal 101. The scan monitoring process is started when the proximity wireless controller 108 of the mobile information terminal 101 detects proximity of another device, and is realized by the CPU 104 executing a state monitoring program which operates in the background.

Referring to FIG. 6, first, the CPU 104 determines whether or not the scan application has been activated (step S601), and if it is determined that the scan application has not been activated, the process proceeds to a step S605. On the other hand, if it is determined that the scan application has been activated, the process proceeds to a step S602.

In the step S602, the CPU 104 determines whether or not the image forming apparatus designated by the active scan application is identical to the image forming apparatus in proximity to the mobile information terminal 101. In the scan application, one of a plurality of identifiable image forming apparatuses (devices) can be selected on the scan setting screen shown in FIG. 13B. In the step S602, the CPU 104 determines identity depending on whether or not an ID associated in advance with the image forming apparatus selected on the scan setting screen matches an ID acquired when the proximity is detected.

If it is determined in the step S602 that the designated image forming apparatus is identical to the image forming apparatus in proximity (YES to the step S602), the CPU 104 transmits identified device touch notification to the active scan application (step S604), followed by terminating the present process. The CPU 104 executing the scan application which has received the identified device touch notification determines that the mobile information terminal 101 has moved close to the currently selected image forming apparatus, thereby regarding that a scan execution button 1207 appearing in FIG. 14A is touched, to thereby perform a scanned image acquisition process based on the conventional control, and execute processing for displaying and operating the scanned image according to the active scan application.

On the other hand, if it is determined in the step S602 that the mobile information terminal 101 has moved close to an image forming apparatus which is different from the one currently selected by the scan application, the CPU 104 transmits an unidentified device touch notification to the scan application (step S603), and the process proceeds to the step S605. The CPU 104 executing the scan application, which has received the unidentified device touch notification, determines that the mobile information terminal 101 moved close to an image forming apparatus which is different from the currently selected image forming apparatus. Further, although the CPU 104 determines that the process cannot be continued with the current settings, the CPU 104 displays a scan-in-progress screen shown in FIG. 14C on the LCD panel 114 so as to continue the scan monitoring process for acquiring the scanned image.

In the step S605, the CPU 104 reads data from the specified area (area in which the token has been written) of the nonvolatile memory of the proximity wireless controller 108.

Next, in a step S606, the CPU 104 determines whether or not the data read in the step S605 is a token, and if it is determined that the data is a token, the process proceeds to a step S607, whereas if not, the present process is immediately terminated. Note that after the scanned image data is acquired, blank information is written in the specified area, and hence if the blank information is read from the specified area in the step S605, it is determined that the data is not a token.

In the step S607, the CPU 104 wirelessly accesses the network address indicated by the acquired token by using the wireless LAN controller 109 or the wireless WAN controller 110. As shown in FIG. 9, the token includes the network address and the connection port number for connecting to the image forming apparatus 201 that has generated the acquired token. Therefore, the wireless LAN controller 109 of the mobile information terminal 101 can directly wirelessly connect to the image forming apparatus 201 via the antenna B 118. Note that the mobile information terminal 101 can also connect to an access point (not shown) in the vicinity thereof to thereby indirectly wirelessly connect to the image forming apparatus 201 via the access point. Which method to be employed depends on the wireless LAN settings of the mobile information terminal 101 and the wireless LAN settings of the image forming apparatus 201. Further, the wireless WAN controller 110 of the mobile information terminal 101 can also connect to a base station of a mobile phone company (communication carrier) via the antenna C 119 to thereby wirelessly connect to the image forming apparatus 201 e.g. via an internal network of the communication carrier and the Internet.

In a step S608, the CPU 104 determines whether or not an error response has been received when accessing the network address indicated by the token by using the above-mentioned method. If an error response has been received, the process proceeds to a step S613. On the other hand, if an error response has not been received, wireless communication between the mobile information terminal 101 and the image forming apparatus 201 is started, whereby the process proceeds to a step S609.

In the step S609, the CPU 104 transmits a state acquisition request to the image forming apparatus 201 to which the mobile information terminal 101 is wirelessly connected, and determines whether or not an error response has been received (step S610). If an error response has been received, the process proceeds to the step S613, whereas if not, the process proceeds to a step S611.

In the step S611, the CPU 104 determines whether or not a response to the state acquisition request, which has been received from the wirelessly connected image forming apparatus 201, indicates normal termination of the scanning process. If the response does not indicate normal termination of the scanning process, the process returns to the step S609. On the other hand, if the response indicates normal termination of the scanning process, the CPU 104 judges that the scanning process by the image forming apparatus 201 is completed, and the process proceeds to a step S612.

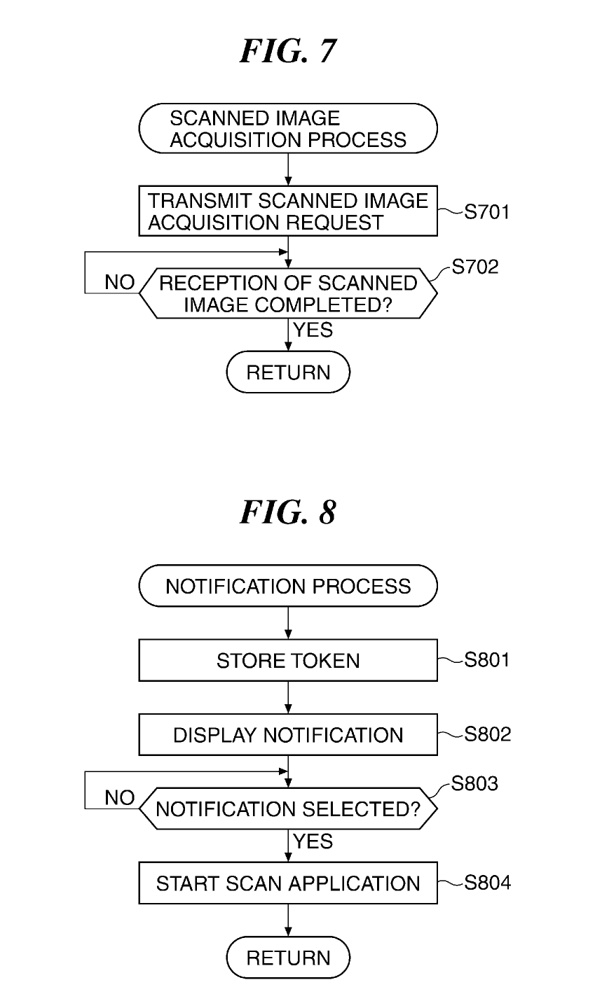

In the step S612, the CPU 104 performs the scanned image acquisition process. FIG. 7 shows details of the scanned image acquisition process which is realized by the CPU 104 executing the state monitoring program in the step S612.

FIG. 7 is a flowchart of the scanned image acquisition process performed in the step S612 in FIG. 6.

Referring to FIG. 7, in a step S701, the CPU 104 transmits the scanned image acquisition request to the image forming apparatus 201. In the image forming apparatus 201 having received the scanned image acquisition request, the steps S405 to S408 in FIG. 4 are executed.

Next, in a step S702, the CPU 104 waits until reception of the scanned image data transmitted from the image forming apparatus 201 is completed, and when the data reception is completed, the CPU 104 terminates the scanned image acquisition process, and returns. Note that when reception of the scanned image data is started, the CPU 104 executing the state monitoring program creates a unique file name to be added to the scanned image data, and writes the scanned image data with the file name e.g. into the NVRAM 106. At this time, the CPU 104 registers the created file name as a scanned image data file name 503 of a token table shown in FIG. 5.

The token table shown in FIG. 5 is formed by the token, denoted by reference numeral 501, acquired in the step S605 in FIG. 6, a notification ID 502 for uniquely identifying a notification, which is assigned to each notification, and the scanned image data file name 503, and is stored in the NVRAM 106.

Referring back to FIG. 6, in the step S613, the CPU 104 determines whether or not the scan application is active, and if it is determined that the scan application is not active, the process proceeds to a step S615. On the other hand, if it is determined that the scan application is active, the process proceeds to a step S614.

In the step S614, the CPU 104 transmits a scanned image acquisition completion notification with the information indicative of the scanned image data (e.g. the scanned image data file name or the like) to the scan application, followed by terminating the present process. The CPU 104 executes the scan application, whereby the screen-in-progress screen shown in FIG. 14C is displayed on the LCD panel 114 according to the unidentified device touch notification received in advance. Upon receipt of the scanned image acquisition completion notification, the scanned image data is acquired from the information indicative of the scanned image data, and a scanned image display screen 1209 as shown in FIG. 14B is displayed on the LCD panel 114.

In the step S615, the CPU 104 executes a notification process, followed by terminating the present process. FIG. 8 shows details of the notification process performed in the step S615.

FIG. 8 is a flowchart of the notification process performed in the step S615 in FIG. 6.

Referring to FIG. 8, in a step S801, the CPU 104 registers the token acquired in the step S605 in FIG. 6 in the token table shown in FIG. 5, and stores the table in the NVRAM 106.

Next, in a step S802, the CPU 104 displays a notification denoted by reference numeral 1204 in FIG. 12B on the LCD panel 114. Note that the notification 1204 appearing in FIG. 12B is automatically hidden when a predetermined time period elapses. Then, by sliding the status line 1202 downward with a finger touching the status line 1202 on the screen, it is possible to change the display to one listing the preceding notifications displayed in the past as indicated by a notification 1205 appearing in FIG. 13A. Further, the display may be performed such that when the scan application is started by touching the SCAN icon, a notification of an unprocessed task, if any, is displayed.

In a step S803, the CPU 104 determines whether or not the notification 1204 appearing in FIG. 12B has been selected (touched). If the notification 1204 has been touched, the CPU 104 proceeds to a step S804, wherein the CPU 104 passes the notification ID 502 of the token table shown in FIG. 5 to the scan application, and starts the scan application. If the scan application is thus activated or has been active, the CPU 104 refers to the token table shown in FIG. 5 to acquire image data indicated by the scanned image data file name 503 associated with the passed identification ID 502, and displays the screen of the scan image display screen 1209 shown in FIG. 14B on the LCD panel 114. Note that in a case where a notification displayed part is touched in the step S804, if an image editing application is usable other than the scan application, whether to start the scan application and the image editing application may be selected.

In the scan application operating on the mobile information terminal, the scanning process is actually enabled by registering the network address of the image forming apparatus in advance. Then, after an original is set on the image forming apparatus, the settings of resolution, a color mode, etc., are made on the scan setting screen as shown in FIG. 13B, and then the scan execution button 1207 is touched. As a consequence, the scan application being executed on the mobile information terminal acquires image data obtained by scanning the original on the image forming apparatus, and displays the image data as the scanned image display screen 1209 as shown in FIG. 14B.

As described above, in the present embodiment, when wireless communication is established by moving the mobile information terminal equipped with the short-range wireless communication function close to the image forming apparatus, even if the image forming apparatus is not an image forming apparatus selected by the mobile information terminal in advance, the image forming apparatus scans the original and stores the obtained image data. Then, the image forming apparatus writes the information called a token, associated with the scanning process, into the mobile information terminal by using the short-range wireless communication. On the other hand, the mobile information terminal acquires the state of the scanning process and the scanned image data, which are associated with the token, from the image forming apparatus by using the token written therein, and displays the state of the scanning process on the screen of the mobile information terminal. Then, the scan application is started by selecting the scan completion notification displayed on the screen of the mobile information terminal, and the mobile information terminal displays the image associated with the scanning process. That is, the user of the mobile information terminal can use an application most suitable for processing electronic data obtained by scanning an original only by moving the mobile information terminal close to the image forming apparatus on which the original is set.

Next, a second embodiment of the present invention will be described. The second embodiment has the same configurations as those of the first embodiment shown in FIGS. 1 and 2, and hence the same components as those of the first embodiment are denoted by the same reference numerals, and description thereof is omitted. The following description will be given only of different points from the first embodiment.

In the first embodiment, the description has been given of the configuration in which the mobile information terminal 101 acquires the information associated with scanning process (e.g. state of the scanning process and scanned image data) from the image forming apparatus 201 by using a token.

In a case where the mobile information terminal 101 has never used the image forming apparatus 201 from which a scanned image is to be obtained, even though a scanned image can be obtained according to the first embodiment, the mobile information terminal 101 is required to acquire connection information, apparatus information, etc., in advance, which are necessary to operate the image forming apparatus 201. In view of this, the mobile information terminal 101 in the present embodiment acquires the connection information and the apparatus information from the image forming apparatus 201 by using a token, and passes the acquired information to the scan application to be set thereby. For example, when a setting button 1210 is touched while the scanned image display screen shown in FIG. 14B is being displayed, the screen is shifted to the scan setting screen shown in FIG. 13B displayed by the scan application. On the scan setting screen, the information associated with the image forming apparatus 201 has been set in advance. A change of a setting e.g. of the resolution area 1206 is received on this screen, and by touching the scan execution button 1207, re-scanning can be executed.

According to the second embodiment, even when a user uses an image forming apparatus which has never been used by the user, by acquiring the connection information and the apparatus information from the image forming apparatus by using a token, it is possible to make detailed settings and execute re-scanning by the scan application.

Next, a third embodiment of the present invention will be described. The third embodiment has the same configurations as those of the first embodiment shown in FIGS. 1 and 2, and hence the same components as those of the first embodiment are denoted by the same reference numerals, and description thereof is omitted. The following description will be given only of different points from the first embodiment.

In the first and second embodiments, as shown in FIG. 7, the mobile information terminal 101 transmits the scanned image acquisition request to the image forming apparatus 201 to thereby acquire the scanned image data.

In the third embodiment, a transmission destination of the scanned image data can also be transmitted together with the scanned image acquisition request. This enables the image forming apparatus 201 to transmit the scanned image data to the mobile information terminal 101 separately.

FIG. 11 is a flowchart of a scanned image acquisition process performed by the mobile information terminal according to the third embodiment.

Referring to FIG. 11, in the step S701, the CPU 104 transmits a scanned image acquisition request to the image forming apparatus.

Next, in a step S1101, the CPU 104 determines whether or not a transmission destination of the scanned image data is designated. If it is determined in the step S1101 that a transmission destination of the scanned image data is not designated, the process proceeds to the step S702.

As a response to the scanned image acquisition request sent in the step S701, the scanned image data is transmitted from the image forming apparatus 201. As a result, the CPU 104 receives the scanned image data (step S702), and when the data reception is completed, the CPU 104 terminates the scanned image acquisition process and returns.

On the other hand, if it is determined in the step S1101 that a transmission destination of the scanned image data is designated, the CPU 104 transmits a scanned image data transmission state acquisition request to the image forming apparatus (step S1102). At this time, the CPU 104 functions as e.g. a destination transmission unit.

The image forming apparatus 201 having received the scanned image acquisition request designating the transmission destination of the scanned image data transmits the scanned image data to the designated destination. The CPU 104 acquires the transmission state of the scanned image data from the image forming apparatus 201, and determines whether transmission of the scanned image data is normally terminated or abnormally terminated (step S1103). The CPU 104 repeats transmission of the scanned image data transmission state acquisition request in the step S1102 until transmission of the scanned image data is completed.

As the transmission destination of the scanned image data, e.g. a file path and an E-mail address via a network protocol, such as CIFS (Common Internet File System) and WebDAV (Web-based Distributed Authoring and Versioning), can be designated. For example, when a CIFS file path is designated as a transmission destination by using a URL, the image forming apparatus 201 accesses the designated device by using the CIFS protocol, and transmits scanned image data to the designated file path. At this time, a token (901 in FIG. 9) which is made different on a scanning process operation-by-scanning process operation basis is set as a base name of the file name, and character strings associated with the scan application, such as “raw”, are set as an extension. Thereafter, by performing the notification process in FIG. 8, completion of the scanning process is displayed on the screen.

In the case where a transmission destination of the scanned image data is set, by touching the notification 1204 appearing in FIG. 12B, an application associated with the transmission destination is started. For example, in a case where a CIFS file path is set as the transmission destination, a Web browser is started to access the file path, whereby a screen for downloading the scanned image is displayed. When the user selects the downloaded scanned image data by using a file operation program, the associated scan application is started, whereby the user can operates the scanned image.

On the other hand, when the file path set at this time designates a nonvolatile memory of the mobile information terminal on which the state monitoring program is operating, the scanned image can be accessed from the scan application. Therefore, it is also possible to directly start the scan application instead of starting the Web browser. Note that whether or not the file path designates the self-apparatus can be determined according to determination of whether or not the host name and address included in the file path are those of the self-apparatus.

Further, in a case where an E-mail address, such as “mailto:foo@example.com”, is set as the transmission destination, the scanned image data is attached to an E-mail using the above file name, in the image forming apparatus, and is transmitted to the designated E-mail address. When transmission of the E-mail is completed, a notification is displayed on the mobile information terminal 101. When the user touches the displayed notification, the token table is referred to, and the information indicated by the scanned image data file name 503 corresponding to the notification ID of the displayed notification is acquired. This information is a URL indicative of mail transmission, and hence an E-mail application is started. Then, when the corresponding mail is selected and then the attached file is designated on the started E-mail application, a screen for downloading the file attached to the mail is displayed. Note that after downloading the file attached to the mail, as described hereinbefore, the scan application can be started by selecting the corresponding file from the file operation program.

As described above, according to the third embodiment, the mobile information terminal is not required to directly perform processing for receiving the scanned image in the scan monitoring process executed upon detection of proximity of the image forming apparatus, and is only required to periodically check completion of scan image transmission from the image forming apparatus. On the other hand, the image forming apparatus is enabled to transmit the scanned image data by starting a connection for the scanned image data separately from the connection using a token. As a consequence, it is possible to separate the processing for responding to a request for checking the transmission state from the mobile information terminal and the processing for transmitting scanned image data, whereby processing is simplified

Further, in the image forming apparatus, the token 901 for uniquely identifying the scanning process and an extension associated with the scan application are set as a file name, and image data is stored as a file having the set file name, and is transmitted to a designated transmission destination. This makes it possible to perform processing by starting the scan application when the file is selected on the mobile information terminal having received the file.

Next, a fourth embodiment of the present invention will be described. The fourth embodiment has the same configurations as those of the first embodiment shown in FIGS. 1 and 2, and hence the same components as those of the first embodiment are denoted by the same reference numerals, and description thereof is omitted. The following description will be given only of different points from the first embodiment.

In the first to third embodiments, the image forming apparatus 201 executes scanning an original in response to detection of proximity of the mobile information terminal 101, and stores the scanned image data obtained by scanning the original in the HDD 206 of the image forming apparatus 201.

On the other hand, the present embodiment differs from the first to third embodiments in that the scanned image data is stored in another image forming apparatus, not shown, or a nonvolatile memory of another mobile information terminal. In this case, a URL or the like, indicative of a storage destination of image data is set as the scanned image data storage location 1003 of the scanned image data table stored in the HDD 206 of the image forming apparatus 201. Since the mobile information terminal 101 accesses the image forming apparatus 201 by using a token, the user is not required to be conscious of whether the image data is stored in the image forming apparatus 201 or in any other image forming apparatus or mobile information terminal.

According to the above-described fourth embodiment, the storage destination of scanned image data can be designated to another image forming apparatus or another mobile information terminal. Therefore, even when the image forming apparatus that performs the scanning process does not have a sufficient free space of memory to store scanned image data, it is possible to achieve the above-described advantageous effects of the present invention.

Although the first to fourth embodiments describe the scanning process and scanned image data, the processing and data are not limited to these, but the embodiments can be applied to any other processing and data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-003231 filed Jan. 10, 2014, which is hereby incorporated by reference herein in its entirety.

What is claimed is:

1. An information processing system including a mobile terminal and an information processing apparatus, that is capable of performing wireless communication between the mobile terminal and the information processing apparatus by using short-range wireless communication and wireless communication which is different from the short-range wireless communication,
wherein the information processing apparatus comprises:
a processing unit configured to perform predetermined processing when the short-range wireless communication is established between the information processing apparatus and the mobile terminal; and
a transmission unit configured to transmit a processing result of the predetermined processing to the mobile terminal by using the wireless communication,
wherein the mobile terminal comprises:
a reception unit configured to receive the processing result from the information processing apparatus by using the wireless communication; and
a starting unit configured to start, when said reception unit has received the processing result, an application associated with the processing result.

2. The information processing system according to claim 1, wherein the mobile terminal further comprises a determination unit configured to determine, when said reception unit has received the processing result, whether or not an application associated with the processing result is active, and
wherein in a case where it is determined by said determination unit that the application associated with the processing result is not active, said starting unit starts the application associated with the processing result.

3. The information processing system according to claim 1, wherein the predetermined processing is processing for generating image data by reading an original, and
wherein said transmission unit transmits the image data to the mobile terminal by using the wireless communication as the processing result.

4. The information processing system according to claim 1, wherein the short-range wireless communication is NFC.

5. A mobile terminal that is capable of performing short-range wireless communication and wireless communication which is different from the short-range wireless communication, comprising:
a first acquisition unit configured to acquire predetermined information from an information processing apparatus by using the short-range wireless communication;
a second acquisition unit configured to connect to the information processing apparatus by using the wireless communication based on the predetermined information to thereby acquire a processing result of predetermined processing performed by the information processing apparatus from the information processing apparatus; and
a starting unit configured to start, when said second acquisition unit has acquired the processing result, an application associated with the processing result.

6. The mobile terminal according to claim 5, further comprising a determination unit configured to determine, when said second acquisition unit has received the processing result, whether or not an application associated with the processing result is active, and
wherein in a case where it is determined by said determination unit that an application associated with the processing result is not active, said starting unit starts the application associated with the processing result.

7. The mobile terminal according to claim 5, wherein the predetermined processing is processing for generating image data by reading an original, and
wherein said second acquisition unit acquires the image data as the processing result.

8. The mobile terminal according to claim 5, wherein said first acquisition unit acquires storage location information indicative of a storage location of the processing result from the information processing apparatus by using the short-range wireless communication, and
wherein said second acquisition unit acquires the processing result from the information processing apparatus based on the storage location information.

9. The mobile terminal according to claim 5, wherein the short-range wireless communication is NFC.

10. A method of controlling a mobile terminal that is capable of performing short-range wireless communication and wireless communication which is different from the short-range wireless communication, comprising:
acquiring predetermined information from an information processing apparatus by using the short-range wireless communication;
accessing the information processing apparatus by using the wireless communication based on the predetermined information to thereby acquire a processing result of predetermined processing performed by the information processing apparatus from the information processing apparatus; and
starting, when the processing result has been acquired, an application associated with the processing result.

11. A non-transitory computer-readable storage medium storing a computer-executable program for performing a method of controlling a mobile terminal that is capable of performing short-range wireless communication and wireless communication which is different from the short-range wireless communication,
wherein the method comprises:
acquiring predetermined information from an information processing apparatus by using the short-range wireless communication;
accessing the information processing apparatus by using the wireless communication based on the predetermined information to thereby acquire a processing result of predetermined processing performed by the information processing apparatus from the information processing apparatus; and
starting, when the processing result has been acquired, an application associated with the processing result.
